(19) United States
(12) Patent Application Publication
(10) Pub. No.: US 2004/0248650 A1
(43) Pub. Date: Dec. 9, 2004

(54) Programmable electronic game apparatus

(76) Inventors: Savalas O. Colbert, Santa Monica, CA (US); Aveis Chughist, Glenwood, CA (US); Ricky Poon, Los Angeles, CA (US)

Correspondence Address: Don Carnegie, Suite 5A PMB540, 5405 Alton Parkway, Irvine, CA, 92604, US

(21) Appl. No.: 10/809,014

(22) Filed: Mar. 25, 2004

Related U.S. Application Data
(60) Provisional application No. 60/457,548, filed on Mar. 25, 2003.

(51) Int. Cl. A63F 13/00

(52) U.S. Cl. 463/37

(57) ABSTRACT

A programmable electronic game apparatus includes a processing circuit, a media reader coupled to the processing circuit, the media reader operable to read program instructions, a touch screen coupled to the processing circuit, the touch screen operable to receive a player input, and an LCD display coupled to the processing circuit, the processing circuit operable to display game indicia on the LCD display in response to the program instructions and change the displayed game indicia in response to player input.

### CROSS-REFERENCE TO RELATED APPLICATION

This application is a continuation of Provisional Application Ser. No. 60/457,548 filed Mar. 25, 2003.

### BACKGROUND OF THE INVENTION

The present invention relates generally to game boards and more particularly to a programmable electronic game apparatus having a touch screen for simulating the look and feel of a conventional game played on a board and emulating multiple board games.

Games played on game boards are exciting and conducive to collective family experiences. Even though advancements in the art have brought video games, computer games, and console type games to market, families and friends often return to conventional board games such as Monopoly® and Scrabble® available from Hasbro, Inc. of Pawtucket, R.I. This is primarily because computer type games do not provide the group feeling of many conventional board games. Furthermore, users of computer type games do not have the same experience of control while using a keyboard or joystick to manipulate items on a screen. Generally, game players like to be able to touch pieces and move them on the game board.

Prior art board games such as Monopoly® and Scrabble® suffer the disadvantage of having pieces that can be easily lost. Loss of such pieces can make playing the game difficult if not impossible. Additionally, young game players have become accustomed to computer type games which provide quick action, sounds and surprises. As such, young game players may not be as interested in playing conventional board games with their families and friends.

Attempts have been made in the prior art to combine the features of computer type games with the features of conventional board games. U.S. Pat. No. 4,215,861 entitled “Electronic Tennis Game” discloses an electronic simulated tennis game played on a game board which includes a matrix of multicolored light-emitting diodes scaled to resemble a tennis court. Each diode is positioned at a grid area and is illuminated to indicate ball and player positions. A keyboard is provided and competing players electronically enter their selected playing positions and the target positions for the ball. Also disclosed are a scoring display, switches to initiate play and light means which instructs the players as to points and movement results. The tennis game is played on a game board which is under the control of a programmed microcomputer which processes each player's inputs according to a simulated tennis game program and displays and computes the results of each player's selections on the game board and displays the results as to an error or a successful volley. The disclosed game suffers the disadvantage of requiring the use of a keyboard.

U.S. Pat. No. 4,279,421 entitled “Electronic Gameboard” discloses an electronic game including logic circuitry which generates and controls the movement of electronic representations of the game board playing pieces. A plurality of electronic displays are arranged to represent the playing surface of the game board, each display being capable of indicating electronic representations of all the playing pieces. The logic circuit initially causes the displays to indicate electronic representations of the playing pieces in a position to begin the game. Associated with each display is a switch which initiates transfer of the electronic representations of the playing pieces between the various displays. The arrangement of the switches and displays allows the displays to be viewed through the switches. The circuit moves an electronic representation of any one of the playing pieces between any two of the displays upon the activation of the switches associated with the two displays. The logic circuitry may incorporate a programmable digital microcomputer and memory. The electronic displays may be implemented with segmental or liquid-crystal circuits. The game board is powered by a rechargeable battery. In one embodiment, a game of chess is implemented. The disclosed game board suffers the disadvantage of requiring activation of switches to effect movement of associated displays.

Another electronic game board is disclosed in U.S. Pat. No. 5,853,327 entitled “Computerized Game Board”. A combination computer game and board game includes a game board, a plurality of toy figures selectably positionable by a player with respect to the game board and apparatus for automatically and non-discretely sensing the location of the toy figures relative to the game board and actuating an audio/visual display sequence in response thereto. Disadvantageously, the disclosed game board requires the use of game pieces which can be easily lost.

As can be seen, attempts have been made to provide electronic game boards which simulate conventional board games. However, these electronic game boards do not offer the look and feel or conventional board games and may require playing pieces which may be lost.

It is desirable to design a programmable electronic game apparatus having a touch screen for simulating the look and feel of a conventional game played on a board and emulating multiple game boards. Preferably the apparatus simulates playing pieces thereby obviating the problem of lost playing pieces.

### SUMMARY OF THE INVENTION

In accordance with one aspect of the invention, a programmable electronic game apparatus includes a processing circuit, a media reader coupled to the processing circuit, a touch screen coupled to the processing circuit, and a display member coupled to the processing circuit, the processing circuit operable to display game indicia on the display member in response to program instructions read by the media reader and receive input from the touch screen.

In another aspect of the invention, a programmable electronic game apparatus includes a processing circuit, a media reader coupled to the processing circuit, a touch screen coupled to the processing circuit, and an LCD display coupled to the processing circuit, the processing circuit operable to display game indicia on the LCD display in response to program instructions read by the media reader and receive input from the touch screen.

In yet another aspect of the invention, a programmable electronic game apparatus includes a processing circuit, a media reader coupled to the processing circuit, the media reader operable to read program instructions, a touch screen coupled to the processing circuit, the touch screen operable to receive a player input, and an LCD display coupled to the processing circuit, the processing circuit operable to display game indicia on the LCD display in response to the program instructions and change the displayed game indicia in response to player input.

These and other feature, aspects, and advantages of the present invention will become better understood with reference to the following drawings, description, and claims.

### BRIEF DESCRIPTION OF THE DRAWINGS

FIG. 1 is a schematic representation of a programmable electronic game apparatus in accordance with the invention;

FIG. 2 is a schematic representation of the programmable electronic game apparatus showing additional features in accordance with the invention;

FIG. 3 is a schematic representation of the programmable electronic game apparatus showing additional features in accordance with the invention; and

FIG. 4 is a schematic representation showing accessories for the programmable electronic game apparatus in accordance with the invention; and

FIG. 5 is a circuit diagram of a programmable electronic game apparatus circuit in accordance with the invention.

### DETAILED DESCRIPTION OF THE INVENTION

The following detailed description is of the best mode of carrying out the invention. The description is not to be taken in a limiting sense, but is made merely for the purposes of illustrating the general principles of the invention, since the scope of the invention is best defined by the appended claims.

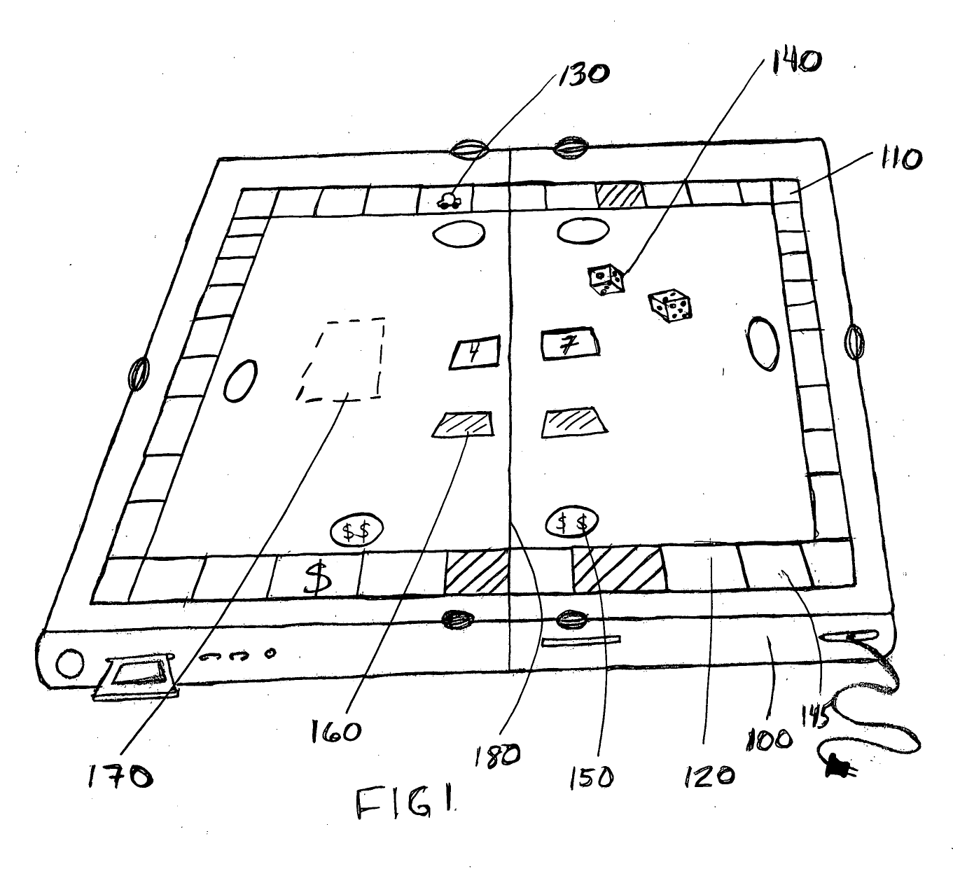

With reference to FIG. 1, a programmable electronic game board 100 includes a housing 110 which may include a rectangular housing to facilitate play by up to four players. Those skilled in the art will appreciate that other housing shapes and configurations may be implemented to accommodate more or less players without departing from the spirit of the invention. The programmable electronic game board 100 may be powered by conventional means including rechargeable means for portable operation.

A display member 120 may be mounted within housing 100 to display visual information to the players. Display member 120 may include an LCD display. In a preferred embodiment of the invention, display member 120 may include a touch screen operable to receive a plurality of simultaneous inputs. Display member 120 may provide a physical stimulus to a player moving a game piece 130 as further described herein.

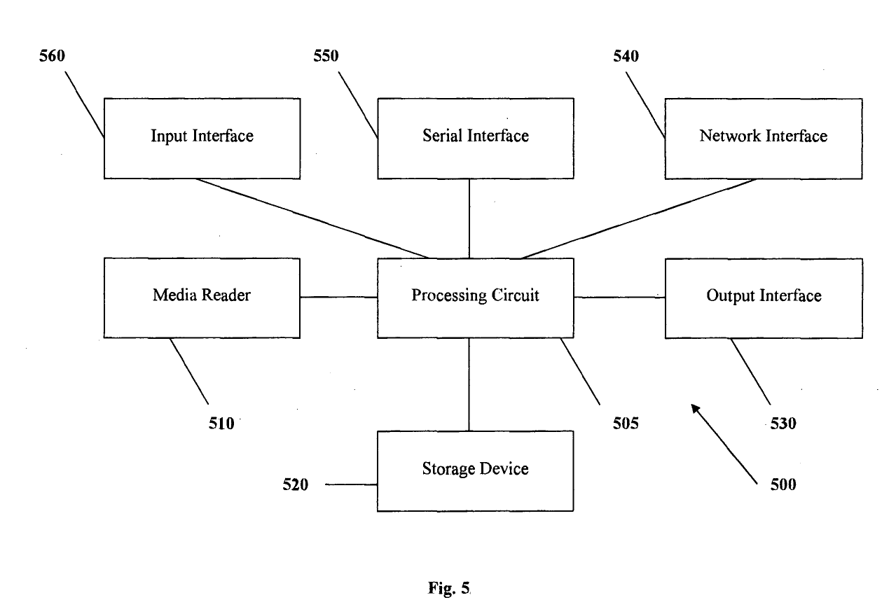

The programmable electronic game board 100 may include a circuit generally designated 500 as shown in FIG. 5. Circuit 500 may include a processing circuit 505 coupled to a storage device 520 including a ROM device for storing an operating system, a RAM device for storing program instructions, and a hard disk drive. Processing circuit 505 may be coupled to a media reader 510 operable to read media such as floppy disks, compact disks, flash memory sticks and the like. Media may include program instructions which when carried out by processing circuit 505, are operable to provide an electronic game to a game player or a plurality of game players. As such the programmable electronic game board 100 of the present invention may be operable to provide a plurality of gaming experiences to the game players. Further, games may be saved to the hard disk drive at any stage of the game, allowing players to return to a saved game at any time.

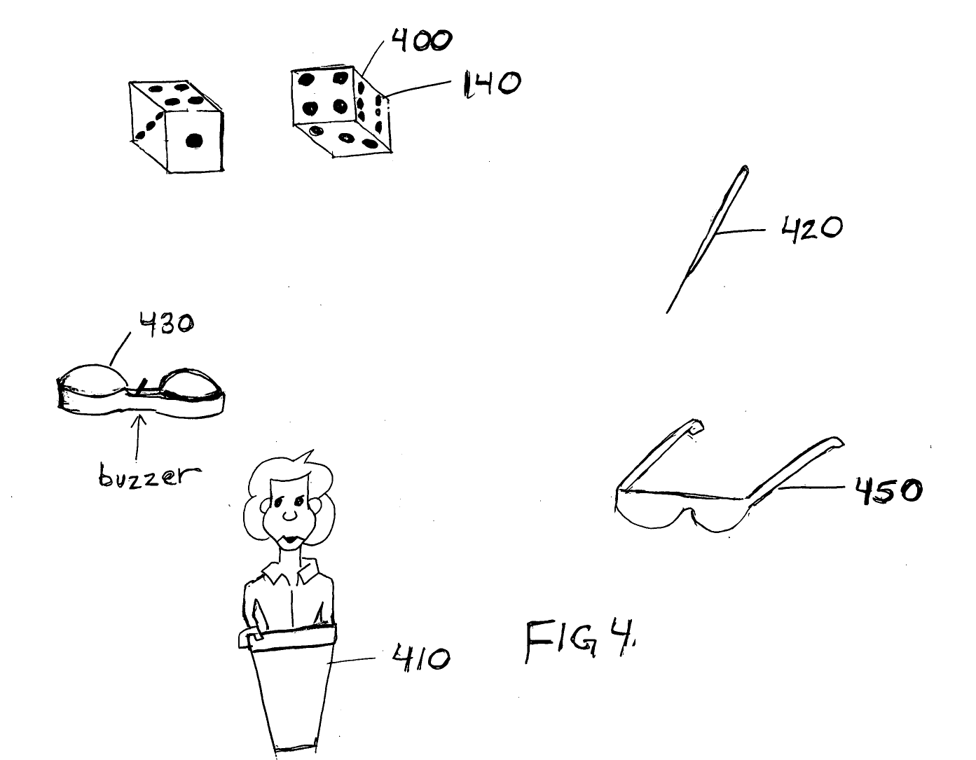

An input interface 560 may be coupled to the processing circuit 505. Input interface 560 may include the touch screen which may be operable to receive player input including the movement of game pieces 130 and manipulation of a stylus 420 (FIG. 4) upon it. Input interface 560 may further include the touch screen sensitive to receive input from at least one die 140. Die 140 may include raised members 400 (FIG. 4) readable by input interface 560. Game players may roll die 140 and the input interface 560 may read the number of raised members 400 touching the input interface 560.

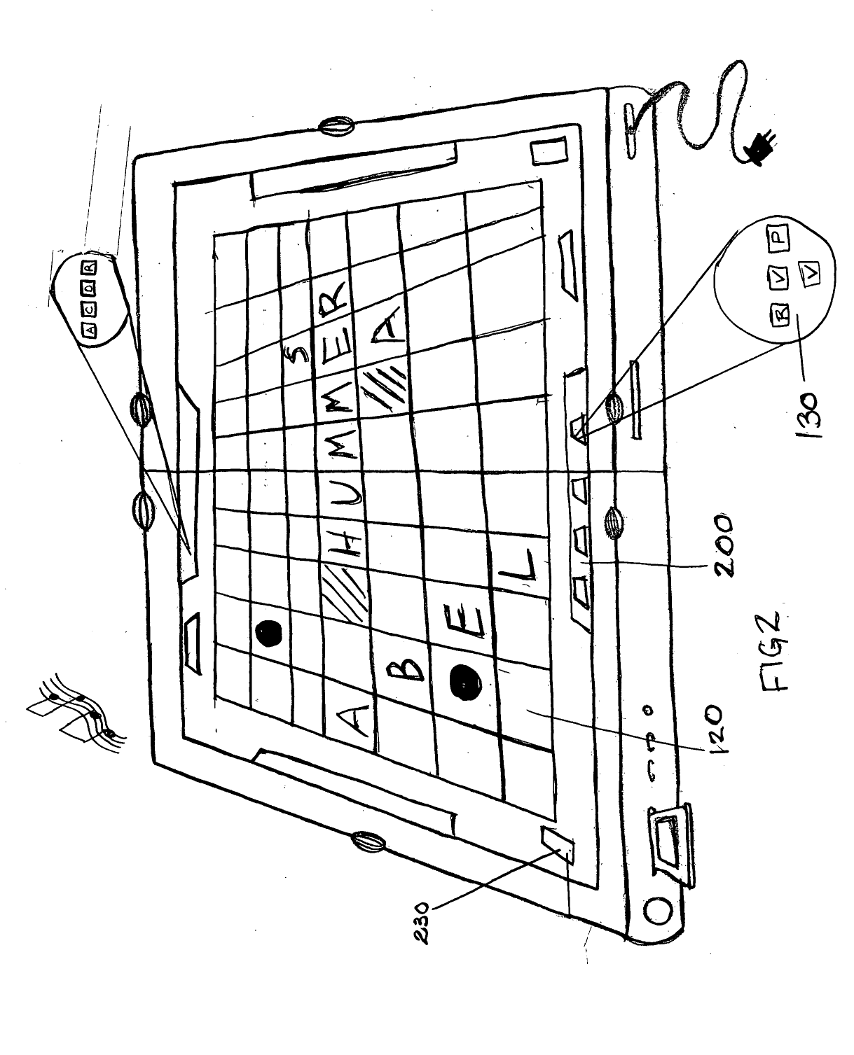

Output interface 530 may be coupled to processing circuit 505 and include display member 120. Display indicia 145 may be displayed by processing circuit 505 corresponding to game instructions read by media reader 510. For example, a Monopoly® type game board is shown displayed in FIG. 1 while a Scrabble® type game board is shown displayed in FIG. 2.

Output interface 530 may include an audio device operable to play music and generate other sounds in response to instructions read by media reader 510 or player input. For example, output interface 530 may be operable to play an audio CD or multimedia DVD read by media reader 510. Additionally, output interface 530 may be operable to provide audio and movement to an animatome 410 (FIG. 4) which may be displayed on display member 120. Animatome 410 may interact with game players in accordance with program instructions.

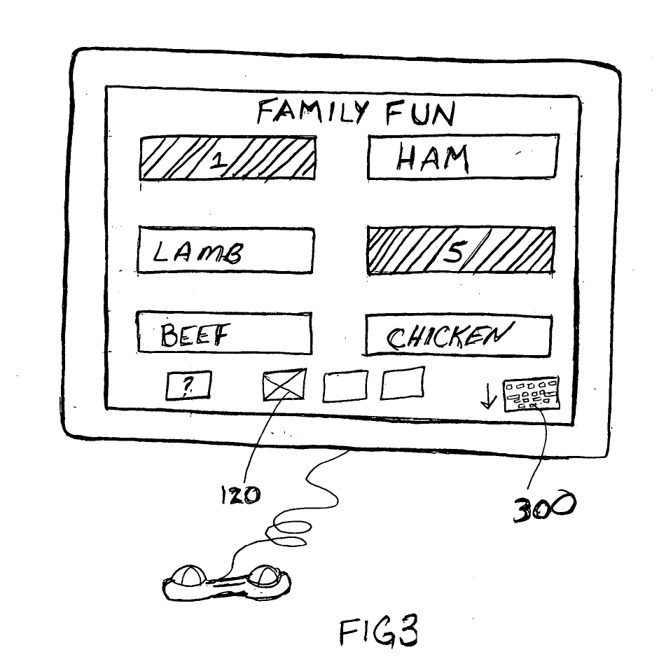

Output interface 530 may be operable to display information including representations of money 150, playing cards 160, game instructions 170, scores 230 (FIG. 2), keyboard 300 (FIG. 3), and game displays 300 (FIG. 3) on display member 120. As play progresses in a game, these representations may change in accordance with program instructions and the course of play. Output interface 530 may be further operable to display images on the display member 120 that when viewed with glasses 450 (FIG. 4) reveal a 3-D image.

With reference to FIG. 2, display member 120 may include at least one partially concealed portion 200. Concealed portion 200 may be formed from polarized glass. Concealed portions 200 may advantageously be used in games requiring that the identity of game pieces 130 be maintained. As shown in FIG. 2, a Scrabble® type game may utilize concealed portions 200 to conceal game pieces 130.

A serial interface 550 may be coupled to processing circuit 505 as shown in FIG. 5. Serial interface 550 may include a USB serial interface for coupling serial devices such as cameras and printers to the processing circuit 505. In this manner, serial data may be downloaded to the storage device 520 and used by processing circuit to customize games in accordance with program instructions. For example, a photo of the players may be stored in storage device 520 and displayed on display member 120. Additionally, player's addresses may be stored in storage device 520 and displayed in a Monopoly® type game. A clock device 430 (FIG. 4) may be coupled to serial interface 550 to provide a game clock such as may be used in a chess match.

With continued reference to FIG. 5, a network interface 540 may be coupled to processing circuit 505. Network interface 540 may include a cellular telephone interface, an Ethernet interface, a WiFi interface, and a IEEE 1394 interface. Network interface 540 provides the ability to play games on the programmable electronic game board 100 interactively.

In another aspect of the invention, the programmable electronic game board 100 may be foldable along partition 180. In this manner the programmable electronic game board 100 may be folded for convenient transport.

In another aspect of the invention, the programmable electronic game board 100 may be formed of partitionable segments 190 and 195 connectable to form the programmable electronic game board 100.

Those skilled in the art will recognize that the programmable electronic game board 100 may be used for any number of purposes when not in use as a game board. For example, a clock or calendar may be displayed on the display member 120 and the programmable electronic game board 100 hung on a wall.

While the programmable electronic game board 100 has been shown in a horizontal configuration, it may be more convenient to stand the programmable electronic game board 100 on a side for use in certain games.

In use, a media including a floppy disk, a CD, and a flash memory card may be read by media reader 510 and program instructions stored in storage device 520. Processing circuit 505 may be operable to execute the stored program instructions and display indicia 145 representative of a conventional game board such as a Monopoly® type game (FIG. 1). Game pieces 130 may be displayed upon the display indicia 145 as well as playing cards 160, representations of money 150, and game instructions 170. Upon rolling dice 140, input interface 560 (FIG. 5) may be operable to read the number of raised members 400. Players may then move game pieces 130 along game display indicia 145 by touching display member 120 where game piece 130 is located and moving to a next position in accordance with the number of raised members 400. The programmable electronic game board 100 may be operable to compare the next position of the moved game piece 130 with the number of raised members 400 and alert the player if the next position is incorrect.

The programmable electronic game board 100 of the present invention advantageously provides a game board which is portable and customizable. Further, the programmable electronic game board 100 provides a touch screen display member which provides game players with the ability to touch the game board and move game pieces 130.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

We claim:

1. A programmable electronic game apparatus comprising:
a processing circuit;
a media reader coupled to the processing circuit;
a touch screen coupled to the processing circuit; and
a display member coupled to the processing circuit, the processing circuit operable to display game indicia on the display member in response to program instructions read by the media reader and receive input from the touch screen.

2. The programmable electronic game apparatus of claim 1, further comprising input and output interfaces.

3. The programmable electronic game apparatus of claim 1, further comprising at least one die having raised members readable by the touch screen.

4. The programmable electronic game apparatus of claim 3, wherein the display member comprises an LCD screen.

5. The programmable electronic game apparatus of claim 1, further comprising a serial interface coupled to the processing circuit.

6. The programmable electronic game apparatus of claim 1, further comprising a network interface coupled to the processing circuit.

7. The programmable electronic game apparatus of claim 6, wherein the network interface comprises an Ethernet interface.

8. The programmable electronic game apparatus of claim 6, wherein the network interface comprises a WiFi interface.

9. The programmable electronic game apparatus of claim 6, wherein the network interface comprises an IEEE 1394 interface.

10. The programmable electronic game apparatus of claim 6, wherein the network interface comprises a cellular telephone interface.

11. The programmable electronic game apparatus of claim 1, further comprising a storage device coupled to the processing circuit.

12. The programmable electronic game apparatus of claim 1, wherein the display member further comprises a polarized portion.

13. The programmable electronic game apparatus of claim 1, wherein the display member is foldable.

14. A programmable electronic game apparatus comprising:
a processing circuit;
a media reader coupled to the processing circuit;
a touch screen coupled to the processing circuit; and
an LCD display coupled to the processing circuit, the processing circuit operable to display game indicia on the LCD display in response to program instructions read by the media reader and receive input from the touch screen.

15. The programmable electronic game apparatus of claim 14, further comprising at least one die having raised members readable by the touch screen.

16. The programmable electronic game apparatus of claim 14, wherein the display member is foldable.

17. The programmable electronic game apparatus of claim 14, further comprising a network interface coupled to the processing circuit.

18. A programmable electronic game apparatus comprising:
a processing circuit;
a media reader coupled to the processing circuit, the media reader operable to read program instructions;
a touch screen coupled to the processing circuit, the touch screen operable to receive a player input; and
an LCD display coupled to the processing circuit, the processing circuit operable to display game indicia on the LCD display in response to the program instructions and change the displayed game indicia in response to player input.

19. The programmable electronic game apparatus of claim 18, wherein the display member is foldable.

20. The programmable electronic game apparatus of claim 18, further comprising at least one die having raised members readable by the touch screen.
